(19) United States
(12) Patent Application Publication
(10) Pub. No.: US 2012/0133236 A1
(43) Pub. Date: May 31, 2012

(54) METHOD FOR PRODUCING BEVELED CAGE ROTOR AND BEVELED CAGE ROTOR

(75) Inventors: Klaus Büttner, Hollstadt (DE); Klaus Kirchner, Ostheim (DE); Michael Müller, Bad Kissingen (DE)

(73) Assignee: SIEMENS AKTIENGESELLSCHAFT, München (DE)

(21) Appl. No.: 13/388,412

(22) PCT Filed: Jul. 27, 2010
(86) PCT No.: PCT/EP2010/060906

§ 371 Date: Feb. 1, 2012

(30) Foreign Application Priority Data
Aug. 3, 2009 (EP) 09167044.8

(51) Int. Cl. H02K 17/16; H02K 15/02

(52) U.S. Cl. 310/211; 29/598

(57) ABSTRACT

The invention relates to a method for producing a beveled cage rotor (1) for an asynchronous machine (2) and to a cage rotor (1) that can be produced by means of such a method. In order to improve the efficiency of the asynchronous machine (2), the cage rotor (1) comprises a laminated rotor core (5) having grooves (4), short-circuit rings (6) made of a first material and case onto the end face of the laminated rotor core (5), and short-circuit bars (3; 11; 12) made of a second material having a higher specific electrical conductivity than the first material and disposed in the grooves (4), wherein the laminated rotor core (5) and the short-circuit bars (3; 11; 12) comprise a bevel and nearly completely fill in an inner groove region (7) as seen in the radial direction of the laminated rotor core (5).

The invention relates to a method for producing a beveled cage rotor for an asynchronous machine and to a cage rotor that can be produced by means of such a method.

New efficiency standards for standard asynchronous machines such as IE1, IE2 or IE3 require a high level of material consumption as the overall length of said machines has to be increasingly long to comply with said standards. In future, it will be increasingly difficult to comply with the growing requirements for the efficiency of the machines by using the conventional aluminum die casting method.

The required levels of efficiency are, however, able to be achieved by using a cage rotor made of copper. Due to the higher electrical conductivity of copper relative to aluminum, greater levels of efficiency may be achieved here, even with shorter overall lengths.

The copper die casting method is known for producing cage rotors made of copper. However, this method is very complex and, in particular with greater shaft heights, is no longer able to be carried out in terms of technology. The requirements for the die casting tool and the process parameters when using molten copper at a temperature of over 1,100° C., are only able to be controlled at very high cost.

A method for producing a cage rotor is disclosed in DE 43 08 683 A1 in which short-circuit bars, which initially consist of copper, are inserted into grooves of a laminated core of the rotor. Said copper bars are connected together on the front face by short-circuit rings. An aluminum die casting process is used for producing these short-circuit rings. When casting the short-circuit rings, the residual cross section remaining in the grooves relative to the inserted copper bars, is at the same time cast using aluminum so that the short-circuit rings are also connected to the die cast bar parts formed in the residual cross section. Moreover, it is known from this publication to bevel such a laminated rotor core after inserting the short-circuit bars by a desired angle of inclination, whereby the running properties of the machine are improved.

An asynchronous machine produced in this manner has the advantage that, due to the copper bars inserted into the grooves, the level of efficiency is similar to an asynchronous machine with a copper die cast rotor but the production costs thereof are markedly lower. This is based on the fact that the die casting process is carried out by using aluminum which has a considerably lower melting temperature than copper.

The object of the invention is to improve the level of efficiency of such an asynchronous machine.

This object is achieved by a method for producing a cage rotor for an asynchronous machine having the features as claimed in claim 1. Such a method comprises the method steps:
beveling a laminated rotor core with grooves,
inserting short-circuit bars of a second material into the grooves of the beveled laminated rotor core,
casting short-circuit rings made of a first material with a lower specific electrical conductivity than that of the second material onto the front face of the laminated rotor core,
   wherein before insertion into the grooves the short-circuit bars have a bevel such that they may be inserted substantially without distortion into the beveled laminated rotor core before an application of the cast first material, such that they almost completely fill up an inner groove region viewed in the radial direction, so that during the casting process the first material is not able to penetrate into the inner groove region.

Moreover, the object is achieved by a cage rotor for an asynchronous machine having the features of claim 7. Such a cage rotor comprises:
a laminated rotor core with grooves,
short-circuit rings of a first material cast onto the front face of the laminated rotor core, and
short-circuit bars arranged in the grooves and made of a second material with a greater specific electrical conductivity than that of the first material, wherein
the laminated rotor core and the short-circuit bars comprise a bevel and
almost completely fill up an inner groove region viewed in the radial direction of the laminated rotor core.

Advantageous embodiments of the invention may be derived from the sub-claims.

The invention permits the economic production of an exceptionally efficient short-circuit rotor for an asynchronous machine with excellent operating properties. By the hybrid construction according to the invention of the cage rotor, it is possible to comply with efficiency standards, such as the aforementioned IE1, IE2, IE3, with a markedly more economical construction relative to a copper die cast rotor. The short-circuit bars of the cage rotor consist of a material with a higher specific conductivity than the material of the short-circuit rings.

In an advantageous embodiment of the invention, for example, aluminum may be used for the first material of the short-circuit rings and copper for the second material of the short-circuit bars. Short-circuit rings made of aluminum may be already cast from molten metal at a temperature of approximately 600° C., whereby this process may be controlled very effectively. Due to the very conductive short-circuit bars, the efficiency of the cage rotor is very good. With the advantageous use of aluminum as the first material, additionally the moment of inertia of the cage rotor, for example in comparison with a solid copper rotor, is markedly reduced which results in an increase in the machine dynamics and a further improvement in the efficiency, in particular in highly dynamic applications.

The invention is based on the recognition that such a cage rotor of hybrid construction may be further improved with regard to its operating behavior when the laminated rotor core has a beveled design. By means of such a bevel, harmonic waves in the magnetic rotary field are avoided, noise reduced and the torque ripple markedly reduced.

A bevel may be produced by the laminated rotor core, which is already provided with the short-circuit bars, being beveled. When using straight bars, however, the groove filling factor is reduced. This is because a bevel of the laminated rotor core provided with the short-circuit bar is only possible when a certain space remains in the grooves after inserting the short-circuit bars.

According to the invention, therefore, the filling of the grooves with the short-circuit bars of the more conductive second material may be increased by the short-circuit bars already having a bevel before insertion into the laminated rotor core, such that, before an application of the cast first material, they may be inserted substantially without distortion into the beveled laminated rotor core, so that they almost completely fill up an inner groove region viewed in the radial direction, so that during the casting process the first material is not able to penetrate into the inner groove region. This has the result that almost exclusively the short-circuit bars made of the relatively conductive second material are arranged in the radial inner region of the laminated rotor core, whilst the remaining residual cross section of the grooves is able to be filled up with the first material. As the first material is less conductive than the second material, start-up bars for the asynchronous machine may be formed very easily in this manner. It is the purpose of these start-up bars to produce a greater electrical resistance during the start-up of the asynchronous machine. As during the start-up, due to the skin effect, current is displaced in the cage rotor from the internal region to the external region, at this time the current flows primarily in the radial outer groove region where the first material is located.

However, if the start-up bars are not desired, advantageously the cross section of the short-circuit bars may also be selected so that the beveled bars completely fill up the grooves. In this manner, the maximum possible copper filling factor is obtained.

In a very advantageous embodiment of the invention, the filling of a residual cross section of the grooves remaining after the insertion of the short-circuit bars is obtained by the grooves, which are provided with the short-circuit bars, being filled with the first material by a die casting method and the short-circuit rings being produced by means of the die casting method. In order to produce the aforementioned start-up bars, the short-circuit bars are inserted into the grooves such that an outer groove region when viewed in the radial direction of the cage rotor is filled with the first material by die casting. In this manner, for example in a further advantageous embodiment, short-circuit bars produced from copper are located on the inner groove region and thus form the operating bars of the asynchronous machine, whilst die cast aluminum start-up bars are arranged in the outer groove region. In this case, the short-circuit rings may also be advantageously produced from aluminum, whereby a relatively lightweight and thus less sluggish short-circuit rotor results overall.

In an advantageous embodiment of the invention, a particularly marked reduction of the harmonic wave content in the rotary field, the torque ripple and the machine noise is achieved by the bevel corresponding to one groove pitch.

In an advantageous embodiment of the invention, avoiding eddy current losses and hysteresis losses in the cage rotor is achieved by the method further including the production of the laminated rotor core by stacking electrical sheets in the axial direction, wherein the electrical sheets are twisted relative to one another such that the aforementioned bevel results.

An asynchronous machine which comprises a stator with a stator winding and a cage rotor which is configured according to one of the embodiments disclosed above is able to be produced considerably more cost-effectively than a copper die cast rotor, but fulfills efficiency standards which may no longer be achieved by an aluminum die cast rotor which is relatively easy to produce and has excellent operating properties as a result of the bevel according to the invention. The efficiency of the machine is particularly high, as by the pre-twisting of the short-circuit bars the entire inner groove region is completely filled with the short-circuit bars.

The invention is described and explained in more detail hereinafter with reference to the exemplary embodiments shown in the figures, in which:

FIG. 1 shows a front view of a twisted short-circuit bar for insertion into grooves of a laminated rotor core according to an embodiment of the invention,

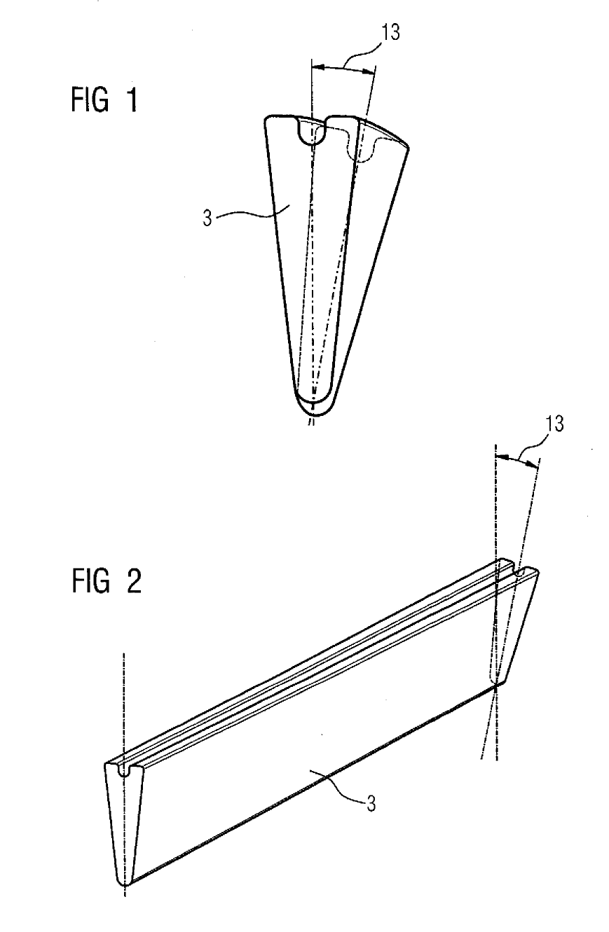

FIG. 2 shows a 3D view of the short-circuit bar according to FIG. 1,

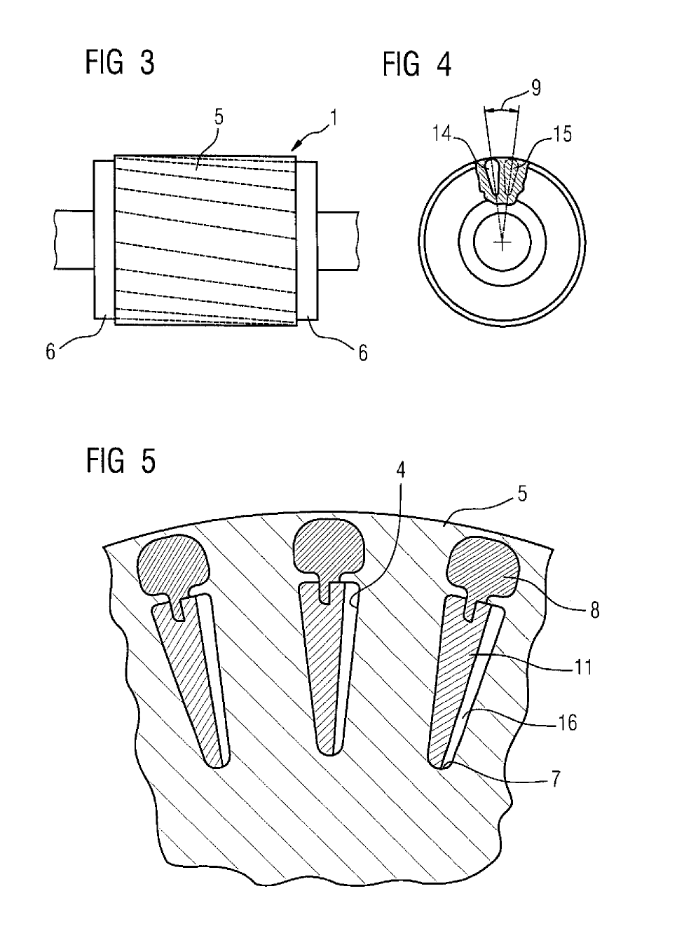

FIG. 3 shows a laminated rotor core according to an embodiment of the invention in side view,

FIG. 4 shows a front view of the laminated rotor core according to FIG. 3,

FIG. 5 shows a sectional view of the laminated rotor core according to FIG. 4 with straight short-circuit bars,

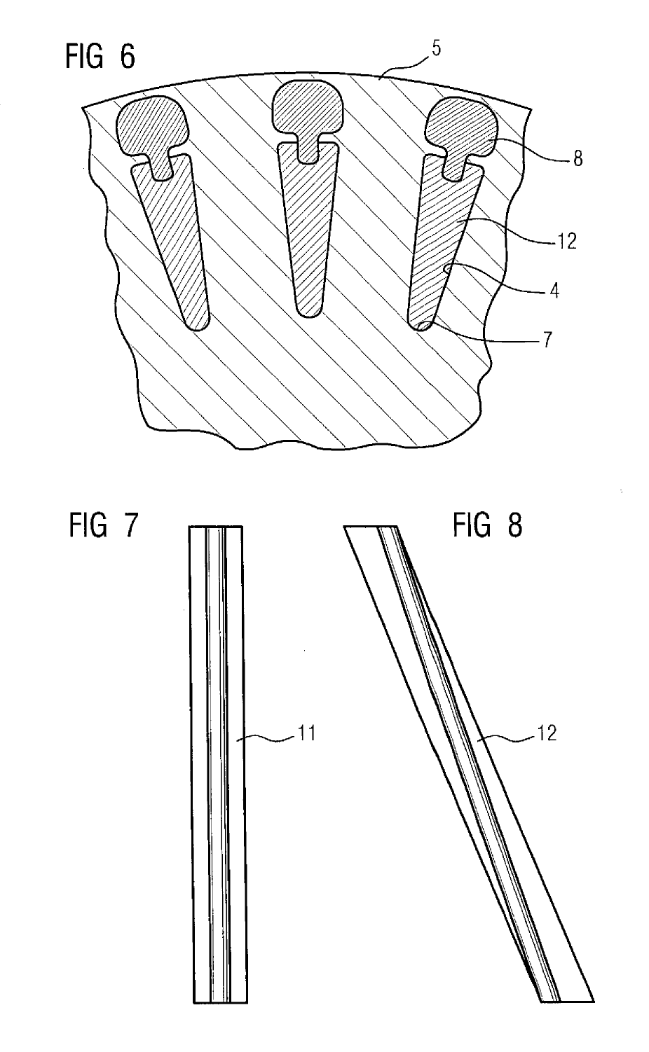

FIG. 6 shows a sectional view of the laminated rotor core according to FIG. 4 with pre-twisted short-circuit bars,

FIG. 7 shows straight short-circuit bars in a 3D view,

FIG. 8 shows pre-twisted short-circuit bars in a 3D view,

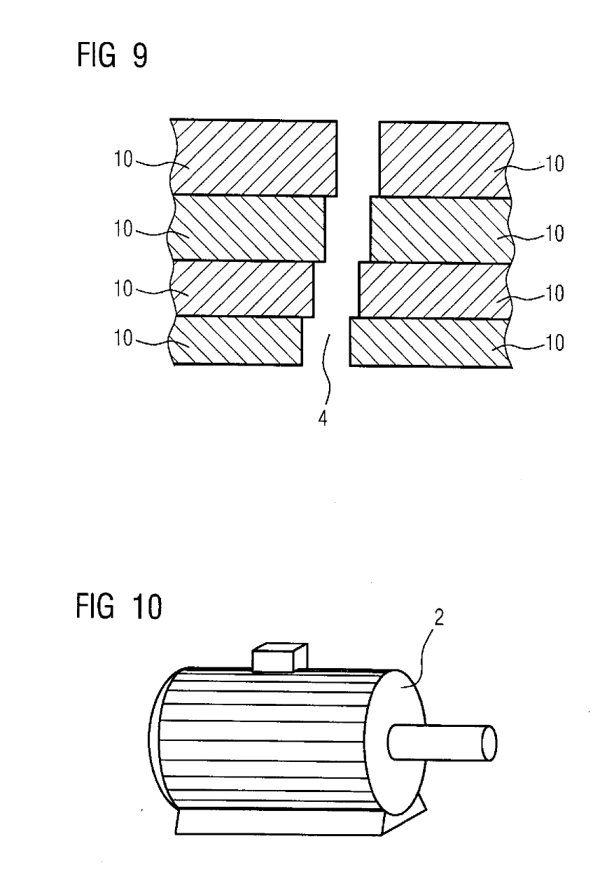

FIG. 9 shows a section through a beveled laminated rotor core comprising axially stacked electrical sheets, and

FIG. 10 shows an asynchronous machine comprising a cage rotor according to an embodiment of the invention.

FIGS. 1 and 2 show a twisted short-circuit bar 3 for insertion into grooves of a laminated rotor core according to an embodiment of the invention. The twisting of the short-circuit bar 3 is represented by a rotational angle 13 which characterizes an offset caused by the twisting of the two short-circuit bar ends in the peripheral direction of the machine. Such a short-circuit bar 3 which is designed, for example, as a copper bar may be inserted almost without distortion into the grooves of a beveled laminated rotor core.

Thus FIG. 3 shows a laminated rotor core 5 of a cage rotor 1 according to an embodiment of the invention in side view. The path of the grooves of the laminated rotor core 5 produced by the bevel is shown in dashed-dotted lines, and into which short-circuit bars are inserted. After inserting these short-circuit bars, in each case short-circuit rings 6 are cast onto the front face of the laminated rotor core 5. During this casting process, remaining residual cross sections in the grooves, which are not filled up with the short-circuit bars, are also filled with the casting material.

FIG. 4 shows a front view of the laminated rotor core 5 according to FIG. 3. It is a partial sectional view in which it may be seen that as a result of the bevel a first groove end 14 on the front face in the peripheral direction is arranged offset by exactly one groove pitch 9 from a second groove end 15 on the front face of the same groove.

FIG. 5 shows a sectional view of the laminated rotor core 5 according to FIG. 4 with straight short-circuit bars 11. The layout of the grooves 4 shown is able to be produced by either the straight short-circuit bars 11 being inserted into a laminated rotor core 5 which is not yet beveled and subsequently the already loaded laminated rotor core 5 being beveled by twisting. In this case, the short-circuit bars 11 are correspondingly brought into an inclined position. However, a free space 16 is produced in a radial inner groove region 7 which has the result that the groove filling factor is reduced in the inner groove region 7. A production method in which the straight short-circuit bars 11 are inserted into an already beveled laminated rotor core 5 produces a similar effect.

It may also be seen in FIG. 5 that a radial outer groove region 8 is filled with the first material. As this material, which is preferably an aluminum die cast material, has a lower electrical conductivity relative to the short-circuit bars 11, start-up bars are produced in this manner for the asynchronous machine.

The use of straight bars 11 has the drawback that the groove filling region is reduced in the radial inner groove region 7.

FIG. 6 shows a sectional view of the laminated rotor core 5 according to FIG. 4 with twisted short-circuit bars 12. It is clearly visible that in this case the entire inner groove region 7 is filled up with the short-circuit bar 12 which is, in particular, a twisted copper bar. This high level of groove filling results in the greatest possible efficiency. In the radial outer groove region 8, a start-up bar made of aluminum die cast material is produced in turn. Due to the almost hundred-percent groove filling in the radial inner groove region 7 with the copper bar, the aluminum die cast material is located almost exclusively in the outer groove region 8 and forms at that point the desired high ohmic resistance of the short-circuit cage in the start-up torque period.

FIG. 7 shows the straight short-circuit bar 11 which has been inserted into the laminated rotor core 5 according to FIG. 5. In contrast, FIG. 8 shows the already twisted short-circuit bar 12 with which according to FIG. 6 the greatest possible groove filling may be achieved.

FIG. 9 shows a section through a beveled laminated rotor core comprising axially stacked electrical sheets 10. The electrical sheets 10 are in this case twisted relative to one another so that the desired groove inclination is produced, for example, by exactly one groove pitch. The laminated rotor core may be produced from the electrical sheets 10 shown, by means of punch packing. Alternatively, the laminated rotor core may be produced by stacking the electrical sheets 10 on a pull-through mandrel with an inclined pull-through slot.

FIG. 10 finally shows an asynchronous machine 2 comprising a cage rotor according to an embodiment of the invention. Due to the hybrid construction of said asynchronous machine 2 which has a cage rotor made of copper bars, which are connected together on the front face via aluminum die cast rings, high levels of efficiency are achieved. As the cage rotor is of beveled design, the asynchronous machine has an exceptionally low harmonic wave content, has very low noise and is characterized by low torque ripple.

What is claimed is:

1.-13. (canceled)

14. A method for producing a cage rotor for an asynchronous machine, comprising:
beveling a laminated rotor core provided with grooves,
beveling short-circuit bars;
inserting the beveled short-circuit bars into the grooves substantially without distortion such that the short-circuit bars substantially occupy an inner groove region of the grooves, as viewed in a radial direction; and
casting short-circuit rings onto a front face of the laminated rotor core, with the short-circuit rings prevented from penetrating the inner groove region by the short-circuit bars and being made of a first material having a specific electrical conductivity which is lower than a specific electrical conductivity of a second material of which the short-circuit bars are made.

15. The method of claim 14, wherein the grooves with the inserted short-circuit bars are filled up with the first material by die casting, thereby producing the short-circuit rings.

16. The method of claim 14, wherein the inserting step includes filling an outer groove region, as viewed in the radial direction with the first material by die casting.

17. The method of claim 14, wherein the first material is aluminum, and the second material is copper.

18. The method of claim 14, wherein the bevel corresponds to one groove pitch.

19. The method of claim 14, further comprising producing the laminated rotor core by stacking electrical sheets in an axial direction of the laminated rotor core in such a manner that the electrical sheets are arranged twisted relative to one another to establish the beveled configuration.

20. A cage rotor for an asynchronous machine, comprising:
a laminated rotor core provided with grooves and having a bevel;
short-circuit rings made of a first material and cast onto a front face of the laminated rotor core; and
short-circuit bars made of a second material having a specific electrical conductivity which is higher than a specific electrical conductivity of the first material, said short-circuit bars being beveled so as to be insertable without distortion into the grooves and substantially occupy an inner groove region as viewed in a radial direction of the laminated rotor core before the short-circuit rings are cast onto the front face of the laminated rotor core so that the first material during casting of the short-circuit rings is prevented from penetrating the inner groove region.

21. The cage rotor of claim 20, wherein the grooves with the inserted short-circuit bars are filled with the first material by die casting, thereby producing the short-circuit rings.

22. The cage rotor of claim 20, wherein the short-circuit bars delimit an external region of the grooves, when viewed in the radial direction, said external region being filled with the first material.

23. The cage rotor as of claim 20, wherein the first material is aluminum and the second material is copper.

24. The cage rotor of claim 20, wherein the bevel corresponds to one groove pitch.

25. The cage rotor of claim 20, wherein the laminated rotor core includes electrical sheets which are stacked in an axial direction, said electrical sheets being arranged twisted relative to one another to establish the bevel.

26. An asynchronous machine, comprising
a stator having a stator winding; and
a cage rotor, said cage rotor comprising a laminated rotor core provided with grooves and having a bevel, short-circuit rings made of a first material and cast onto a front face of the laminated rotor core, and short-circuit bars made of a second material having a specific electrical conductivity which is higher than a specific electrical conductivity of the first material, said short-circuit bars being beveled so as to be insertable without distortion into the grooves and substantially occupy an inner groove region as viewed in the radial direction of the laminated rotor core before the short-circuit rings are cast onto the front face of the laminated rotor core so that the first material during casting of the short-circuit rings is prevented from penetrating the inner groove region.

27. The asynchronous machine of claim 26, wherein the grooves with the inserted short-circuit bars are filled with the first material by die casting, thereby producing the short-circuit rings.

28. The asynchronous machine of claim 26, wherein the short-circuit bars delimit an external region of the grooves, when viewed in the radial direction, said external region being filled with the first material.

29. The asynchronous machine as of claim 26, wherein the first material is aluminum and the second material is copper.

30. The asynchronous machine of claim 26, wherein the bevel corresponds to one groove pitch.

31. The asynchronous machine of claim 26, wherein the laminated rotor core includes electrical sheets which are stacked in an axial direction, said electrical sheets being arranged twisted relative to one another to establish the bevel.
